(19) United States
(12) Patent Application Publication
(10) Pub. No.: US 2006/0022843 A1
(43) Pub. Date: Feb. 2, 2006

(54) Public advance warning system for emergency vehicles

(76) Inventor: Michael J. Sommers, San Diego, CA (US)

Correspondence Address: DAVID R PRESTON & ASSOCIATES APC, 12625 HIGH BLUFF DRIVE, SUITE 205, SAN DIEGO, CA, 92130, US

(21) Appl. No.: 10/902,236

(22) Filed: Jul. 29, 2004

(51) Int. Cl. G08G 1/00

(52) U.S. Cl. 340/902; 340/904

(57) ABSTRACT

The present invention relates to warning systems, and more particularly to public advance warning system to occupants of non-emergency vehicles of the presence of an active emergency vehicle in the vicinity. The present invention can be used to enhance the awareness of drivers and passengers of non-emergency vehicles who travelling near or in the path of emergency vehicles that are active in response to an emergency. The present invention utilizes audio-visual warning in order to indicate that active emergency vehicles are in the vicinity. The present invention is particularly adaptable to be integrated into the instrument panel of non-emergency automobiles or as a stand-alone warning system inside the non-emergency automobile.

### FIELD OF INVENTION

The present invention relates generally to the field of warning systems, and more particularly to public advance warning system to occupants of non-emergency vehicles of the presence of an active emergency vehicle in the vicinity.

### BACKGROUND OF THE INVENTION

Many modern automobiles have interiors that are designed to reduce the outside noise, providing for a quiet environment for listening to music or conversing with passengers and an overall relaxing travel. One adverse side effect of reducing outside noise in the interior of an automobile is that all outside noise is reduced, including the sound of emergency vehicle sirens. In a well designed automobile with a quiet interior, it is difficult to be aware of an active emergency vehicle responding to an emergency.

While emergency vehicles are equipped with sirens, flashing lights, horns and other warning systems, the quiet interiors of a well designed modern automobile make it difficult for drivers to be aware of active emergency vehicles, unless the emergency vehicle is in very close vicinity of the automobile or if the driver can see the emergency vehicle through the windows or the mirrors of the automobile. There exists a need for further improvements in the effectiveness and safety of providing a quiet automobile interior for drivers, while at the same time ensuring that the driver is made aware of the presence of active emergency vehicles are desirable, and the present invention addresses the existing problems and provides related benefits.

### SUMMARY OF THE INVENTION

The present invention relates generally to the field of warning systems, and more particularly to public advance warning system to occupants of non-emergency vehicles of the presence of an active emergency vehicle in the vicinity. The present invention can be used to enhance the awareness of drivers and passengers of non-emergency vehicles travelling near or in the path of emergency vehicles that are active in response to an emergency. The present invention utilizes audio-visual warning in order to indicate that active emergency vehicles are in the vicinity. The present invention is particularly adaptable to be integrated into the instrument panel of non-emergency automobiles or as a stand-alone warning system inside the non-emergency automobile.

Many avoidable accidents and collisions occur, especially at intersections, between emergency vehicles and non-emergency vehicles because the driver of the non-emergency vehicle is not aware the presence of the emergency vehicle, even though the sirens and flashing lights of the emergency vehicle is active until it is too late. The present invention recognizes that further accidents or injuries can be avoided during an emergency situation or at the scene of an accident if the approaching vehicles become aware of the presence of the emergency vehicle and emergency personnel in due time to be able to respond and also without necessarily seeing or hearing the emergency vehicle in action in order become more cautious in their approach. The present invention is particularly helpful for enhancing the awareness of drivers and passengers of non-emergency vehicles travelling near or in the path of emergency vehicles that are active in response to an emergency, and therefore, providing a safer environment near the scene of an accident or in the path of emergency vehicles.

A first aspect of the present invention includes a public advance warning system including a transmitter aboard an emergency vehicle that is capable of transmitting an emergency signal, the transmitter adapted to transmit the emergency signal when the emergency vehicle is active during an emergency. The present invention also includes a receiver aboard a non-emergency vehicle that is capable of receiving the emergency signal from the transmitter when the transmitter is transmitting the emergency signal, the receiver including an audio-visual means for generating a warning to the occupants of the non-emergency vehicle that the active emergency vehicle is in the vicinity.

A second aspect of the present invention includes a public advance warning system including means for transmitting an emergency signal aboard an emergency vehicle, the means for transmitting adapted to transmit the emergency signal when the emergency vehicle is active during an emergency. The present invention also includes means for receiving the emergency signal aboard a non-emergency vehicle when the means for transmitting is transmitting the emergency signal, the means for receiving including an audio-visual means for generating a warning to the occupants of the non-emergency vehicle that the active emergency vehicle is in the vicinity.

### DETAILED DESCRIPTION OF THE INVENTION

Introduction

The present invention recognizes that awareness of drivers and passengers of non-emergency vehicles can be enhanced, particularly when travelling near or in the path of emergency vehicles that are active in response to an emergency.

As a non-limiting introduction to the breadth of the present invention, the present invention includes several general and useful aspects, including:

1) A public advance warning system including a transmitter aboard an emergency vehicle that is capable of transmitting an emergency signal, the transmitter adapted to transmit the emergency signal when the emergency vehicle is active during an emergency; and

a receiver aboard a non-emergency vehicle that is capable of receiving the emergency signal from the transmitter when the transmitter is transmitting the emergency signal, the receiver including an audio-visual means for generating a warning to the occupants of the non-emergency vehicle that the active emergency vehicle is in the vicinity.

2) A public advance warning system including means for transmitting an emergency signal aboard an emergency vehicle, the means for transmitting adapted to transmit the emergency signal when the emergency vehicle is active during an emergency; and means for receiving the emergency signal aboard a non-emergency vehicle when the means for transmitting is transmitting the emergency signal, said means for receiving including an audio-visual means for generating a warning to the occupants of the non-emergency vehicle that the active emergency vehicle is in the vicinity.

Further objectives and advantages of the present invention will become apparent as the description proceeds. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

I. A Public Advance Warning System

The present invention can be used to enhance the awareness of drivers and passengers of non-emergency vehicles travelling near or in the path of emergency vehicles that are active in response to an emergency. The present invention includes a public advance warning system including a transmitter aboard an emergency vehicle that is capable of transmitting an emergency signal. The transmitter can be any transmitter capable of transmitting a signal, preferably, the transmitter is capable of transmitting a radio frequency in a designated range of frequencies. The designated range of radio frequencies is preferably designated for emergency signal of the present invention, such that interference with other unrelated transmitters of radio frequency are minimized or eliminated. By way of example, the designated range of radio frequencies for the transmitter of the present invention may be about 400 megahertz to about 500 megahertz, or it may be about 900 megahertz to about 1000 megahertz.

The transmitter of the present invention can be adapted to transmit the emergency signal when the emergency vehicle is active during an emergency. Preferably the strength of the radio frequency of the transmitter is configured to cover an area having a radius of about one mile to about two miles in all directions, such that any receiver that has been configured to receive the designated signal can pick up the activated emergency signal of the transmitter during emergency and providing a warning that active emergency vehicles are in the vicinity.

The transmitter of the present invention aboard the emergency vehicle can be configured to get its operational power from the emergency vehicle's battery or it can be powered by disposable batteries, or a combination of these two configurations. Furthermore, the transmitter of the present invention may be configured as a stand-alone unit, which may be activated by personnel of the emergency vehicle by way of a switch or other means during an emergency, or the transmitter of the present invention may be configured to be connected to and activated or actuated by the emergency vehicle's emergency lights and/or siren, or the transmitter of the present invention can be configured to become activated by a combination of these two configuration, such that for example, the transmitter can be activated by way of a switch even though the emergency lights or siren of the emergency vehicle are not active, or vice versa.

The present invention also includes a receiver aboard a non-emergency vehicle that is capable of receiving the emergency signal from the transmitter when the transmitter is transmitting the emergency signal from the emergency vehicle. The receiver of the present invention aboard the non-emergency vehicle can be can be configured to get its operational power from the non-emergency vehicle's battery either by direct wiring or through, for example, the cigarette lighter jack of the non-emergency vehicle, or the receiver can be powered by disposable batteries, or a combination of these configurations. Furthermore, the receiver of the present invention may be configured as a stand-alone unit, which can be taken out and be used by multiple non-emergency vehicles, or the receiver of the present invention may be integrated into the instrument panel of the non-emergency vehicle.

The receiver of the present invention includes an audio-visual means for generating a warning to the occupants of the non-emergency vehicle that the active emergency vehicle is in the vicinity. The audio-visual means of the present invention may be any audio-visual means capable of warning occupants of the non-emergency vehicle that the receiver of the present invention has picked up the emergency signal of emergency vehicles in the vicinity. Having an audio-visual warning system is more advantageous than other systems because the occupants of the car will be able to become aware of the presence of active emergency vehicles in the vicinity without relying on seeing or hearing the siren of the emergency vehicles. The audio-visual means may include, for example, means for producing a buzzing sound or an alarm type sound as the audio warning, and a colored warning light as the visual warning. Preferably the visual warning includes a warning light having an amber colored lens, and more preferably the amber colored lens of the warning light may include a warning message, such as for example, “EMERGENCY VEHICLE APPROACHING” or other similar warning messages.

### EXAMPLES

### Example I

### A Public Advance Warning System

An example of the radio transmitter of the present invention is configured to have a power supply of about 9 to about 12 volts, which uses a car's battery as power supply and has a buck switching regulator. The transmitter has a low-power 8 bit microcontroller with sleep mode. The transmitter has program, internal firmware only with no random access memory. The transmitter is configured to transmit emergency frequencies at 400 to 500 megahertz or at 900-1000 megahertz. The transmitter has an integrated coplanar antenna with an optional external antenna via SMB connector jack. The transmitter has a green LED indictor for indication that power is being delivered to the device and a red LED indicator for indicating the device is transmitting the emergency signal. The LED indicators have a programmable flash rate of 1 to 15 flashed per second. The transmitter has a power switch and an optional transmitter on switch. The transmitter can be powered by a power connector for use with cigarette lighter jack, wall regulator, or fixed car wiring. The transmitter's optimal operation condition is between 0° Celsius to 55° Celsius (32° Fahrenheit to 131° Fahrenheit) and 10% to 90% humidity (non-condensing).

A radio receiver is configured to have a power supply of about 3 to about 15 volts. A 3 volt Lithium coin cell batter is used to power the receiver, and the device can include a boost switching regulator for use with internal battery and linear regulator for use with the car's battery. The receiver has a low-power 8 bit microcontroller with sleep mode having 50% duty cycle with 2.5 second on and 2.5 second off and able to awake in less than 10 millisecond. The receiver has program, internal firmware only with no random access memory. The receiver is configured to receive emergency frequencies at 400 to 500 megahertz or at 900-1000 megahertz. The receiver has an integrated coplanar antenna. The receiver includes one amber colored LED indicator having “EMERGENCY VEHICLE APPROACHING” positive message, which becomes activated only when the transmitter is within a one mile range of the receiver. The LED indicator has a programmable flash rate of 1 to 15 flashed per second. The receiver also includes an annunciator having 300 to 1 kilohertz pulse tone. The receiver can be powered by a power connector for use with cigarette lighter jack, wall regulator, or fixed car wiring. The receiver's optimal operation condition is between 0° Celsius to 55° Celsius (32° Fahrenheit to 131° Fahrenheit) and 10% to 90% humidity (non-condensing).

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims.

What is claimed is:

1. A public advance warning system comprising:
a transmitter aboard an emergency vehicle that is capable of transmitting an emergency signal, said transmitter adapted to transmit said emergency signal when said emergency vehicle is active during an emergency; and
a receiver aboard a non-emergency vehicle that is capable of receiving said emergency signal from said transmitter when said transmitter is transmitting said emergency signal, said receiver comprising an audio-visual means for generating a warning to the occupants of said non-emergency vehicle that said active emergency vehicle is in the vicinity.

2. The system of claim 1, wherein said emergency signal comprises a radio frequency.

3. The system of claim 2, wherein the strength of said radio frequency is adapted to cover an area of about one mile to about two miles in all directions.

4. The system of claim 1, wherein said transmitter is powered by said emergency vehicle's battery.

5. The system of claim 1, wherein said transmitter is powered by one or more disposable batteries.

6. The system of claim 1, wherein said transmitter comprises a stand-alone unit and is activated by personnel of said emergency vehicle by way of a switching means.

7. The system of claim 1, wherein said transmitter is adapted to be connected to and activated by said emergency vehicle's emergency lights and/or emergency siren.

8. The system of claim 1, wherein said receiver is powered by said non-emergency vehicle's battery.

9. The system of claim 1, wherein said receiver is powered by one or more disposable batteries.

10. The system of claim 1, wherein said receiver is integrated into the instrument panel of said non-emergency vehicle.

11. The system of claim 1, wherein said audio-visual means comprises a colored light source and a means for producing a buzzing sound or an alarm type sound.

12. The system of claim 11, wherein said colored light source comprises an amber colored lens and a light source behind said amber colored lens.

13. The system of claim 12, wherein said an amber colored lens comprises a warning message.

14. A public advance warning system comprising:
means for transmitting an emergency signal aboard an emergency vehicle, said means for transmitting adapted to transmit said emergency signal when said emergency vehicle is active during an emergency; and
means for receiving said emergency signal aboard a non-emergency vehicle when said means for transmitting is transmitting said emergency signal, said means for receiving comprising an audio-visual means for generating a warning to the occupants of said non-emergency vehicle that said active emergency vehicle is in the vicinity.

15. The system of claim 14, wherein said emergency signal comprises a radio frequency.

16. The system of claim 15, wherein the strength of said radio frequency is adapted to cover an area of about one mile to about two miles in all directions.

17. The system of claim 14, wherein means for transmitting comprises a stand-alone unit and is activated by personnel of said emergency vehicle by way of a switching means.

18. The system of claim 14, wherein said means for transmitting is adapted to be connected to and activated by said emergency vehicle's emergency lights and/or emergency siren.

19. The system of claim 14, wherein said means for receiving is integrated into the instrument panel of said non-emergency vehicle.

20. The system of claim 14, wherein said audio-visual means comprises a colored light source and a means for producing a buzzing sound or an alarm type sound.
